(19) United States
(12) Patent Application Publication
(10) Pub. No.: US 2017/0008594 A1
(43) Pub. Date: Jan. 12, 2017

(54) POWERED UNICYCLE DEVICE

(71) Applicant: Timur Artemev, Haslemere Surrey (GB)

(72) Inventor: Timur Artemev, Haslemere Surrey (GB)

(21) Appl. No.: 15/116,443

(22) PCT Filed: Feb. 2, 2015
(86) PCT No.: PCT/GB2015/050265

§ 371 Date: Aug. 3, 2016

(30) Foreign Application Priority Data
Feb. 4, 2014 (GB) 1401887.3

(51) Int. Cl. B62K 11/00; B60L 11/18; B60K 7/00; B62K 1/00; B62J 25/00

(52) U.S. Cl. CPC B62K 11/007; B62K 1/00; B62J 25/00; B60K 7/0007; B60L 11/1877; B60L 2200/14; B60K 2007/0061

(57) ABSTRACT

A powered unicycle device, comprising: a single wheel; a motor adapted to drive the wheel; a balance control system adapted to maintain fore-aft balance of the unicycle device by controlling the motor; at least one foot platform for supporting a user of the unicycle device; and a casing comprising at least two casing portions adapted to be movable between a closed configuration, in which the outer rim of the wheel is substantially covered, and an open configuration, in which at least a portion of the outer rim of the wheel is exposed for contacting a ground surface.

### FIELD OF INVENTION

The present invention relates to powered single-wheeled devices and more particularly to powered unicycles with self-balancing functionality.

### BACKGROUND TO THE INVENTION

Powered self-balancing vehicles for use while standing are known. Such vehicles include two-wheeled vehicles and single-wheeled vehicles (i.e. unicycles).

In a powered self-balancing unicycle, an electronic or mechanical system that controls the wheel in the appropriate direction is typically used to achieve fore-and-aft balance. This type of automatic fore-and-aft balance technology is well known and described, for example, in U.S. Pat. No. 6,302,230. A sensor and electronic equipment are typically provided. Information detected by the sensor and the electronics is relayed to a motor. The motor drives the wheel in the appropriate direction and at sufficient speed to maintain fore-and-aft balance.

Known embodiments of a powered self-balancing unicycle do not include a handle bar supported by a shaft. For example, U.S. patent application Ser. No. 12/281,101 presents a single wheel, coupled to a frame to which two platforms (one on each side of the wheel) are attached.

### SUMMARY OF THE INVENTION

According to a first aspect of the invention, there is provided a powered unicycle device, comprising: a single wheel; a motor adapted to drive the wheel; a balance control system adapted to maintain fore-aft balance of the unicycle device; at least one foot platform for supporting a user of the unicycle device; and a casing comprising at least two casing portions adapted to be movable between a closed configuration, in which the outer rim of the wheel is substantially covered, and an open configuration, in which at least a portion of the outer rim of the wheel is exposed for contacting a ground surface.

There is proposed a powered unicycle with self-balancing functionality that may be carried by a user when not in use, wherein a casing encloses the wheel and protects the wheel from coming into contact with external objects or the user for example. The wheel may therefore be protected from damage during transit. Also, when carrying the unicycle, the casing may protect a user or external object from coming into contact with dirt, fluid and/or dust present on the wheel.

Embodiments may allow for rapid deployment by being movable from a closed (e.g. stowed) configuration, wherein the wheel is encased by the casing, to an open (e.g. activated) configuration, wherein part of the outer rim of the wheel is exposed for contacting a ground support surface.

For the avoidance of doubt, reference to a single wheel should be taken to mean the generally circular unit that is positioned between the legs of a user and adapted to rotate about an axis to propel the unicycle in a direction during use. The single wheel may therefore be formed from one or more tyres and/or hubs that are coupled together (via a differential, for example). For example, an embodiment may comprise a single wheel having a single rim with a plurality of separate tyres fitted thereon. Alternatively, an embodiment may comprise a single wheel formed from a plurality of rims (each having a respective tyre fitted thereon), wherein the plurality of rims are coupled together via a differential bearing arrangement.

Embodiments may employ an activating system adapted to move the casing from the closed configuration to the open configuration. Such an activating system may be used to expose part of the outer rim of the wheel upon occurrence of one or more predetermined conditions indicating the user desires to use the unicycle. Such embodiments may therefore enable quick and easy deployment from a closed configuration (wherein the wheel is covered for protection) to an open configuration (wherein the wheel is readied for contact with the ground). This deployment may require little or no input from the user, but instead may be automatically achieved when the user and/or unicycle performs one or more predetermined actions or movements.

Embodiments may comprise one or more handles. Such a handle may be used to hold the unicycle above the ground, for example to enable a user to lift, carry, convey or place the unicycle. The handle may also form part of the activating system so that the handle (or a part thereof) may be used to initiate the activating system and move the casing from the closed configuration to the open configuration.

The activating system may responsive to an indication that the user intends to use the unicycle device. Such an indication may be provided from: an accelerometer system which detects movement of the unicycle device; an input interface for receiving a user input; movement of a part of the activating system relative to the casing; actuation of a switch, or any combination thereof.

The at least one foot platform may be movable between a stowed position and an active position by moving the handle relative to the casing. For example, the handle may be designed such that when it is pulled or pushed from/to the casing it causes the activating system to move the unicycle from the closed configuration to the open configuration.

In embodiments, a first casing portion may be adapted to rotate relative to a second casing portion. For example, the first casing portion may be adapted to rotate an axis of rotation (which may be the same as, or offset from, the axis of rotation of the wheel), whereas the second casing portion may remain in a fixed position. Alternatively, both the first and second casing portions may be adapted to rotate in opposite directions about a common axis of rotation, wherein the common axis of rotation may be the same as the axis of rotation of the wheel, or offset therefrom.

In an embodiment, the at least one foot platform may be coupled to the first casing portion. In this way, the foot platform may be moved from a stowed position to an exposed position as a result of moving the casing from the closed configuration to the open configuration.

The wheel may be hubless, and unicycle may further comprise a drive wheel driven by said motor and in contact with the inner rim of the wheel.

### BRIEF DESCRIPTION OF THE DRAWINGS

An example of the invention will now be described with reference to the accompanying diagrams, in which:

FIG. 1 is an isometric view of an embodiment of a powered unicycle device in a closed configuration;

FIG. 2 is an exploded diagram of components internal to the casing of FIG. 1,

FIGS. 3A & 3B are side and front elevations, respectively, of the embodiment of FIG. 1, wherein the casing is moving between a closed and open configuration;

FIGS. 4A & 4B are side and front elevations, respectively, of the embodiment of FIG. 1, wherein the casing is in an open configuration and the foot platforms are in a stowed configuration;

FIG. 5 is an isometric view of the embodiment of FIG. 1, wherein the casing is in an open configuration and the foot platforms are in a stowed configuration;

FIGS. 6A & 6B are side and front elevations, respectively, of the embodiment of FIG. 1, wherein the casing is in an open configuration and the foot platforms are in an active configuration;

FIG. 7 is an isometric view of the embodiment of FIG. 1, wherein the casing is in an open configuration and the foot platforms are in an active configuration;

FIG. 8A is an isometric view of an alternative embodiment arranged in a closed configuration; and

FIG. 8B is an isometric view of the embodiment of FIG. 8A wherein the casing has been moved to an open configuration.

### DETAILED DESCRIPTION

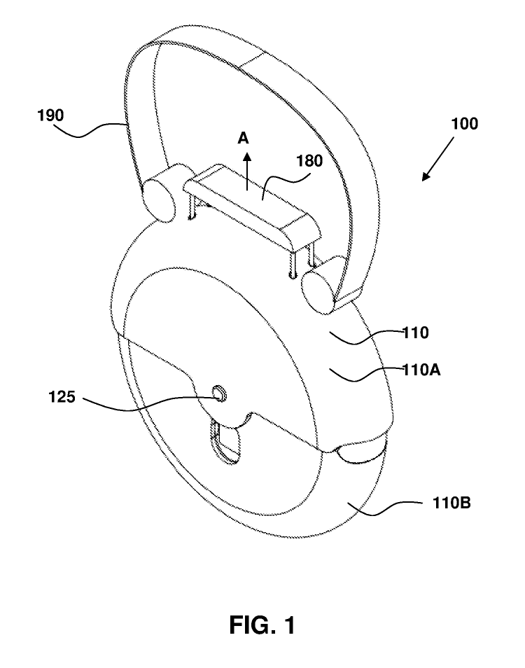

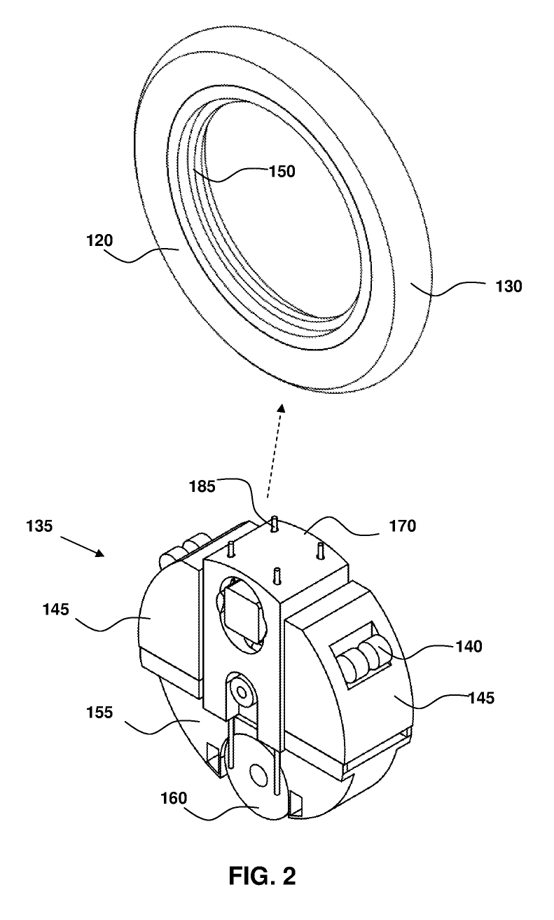

FIGS. 1-5 shows one embodiment of a powered unicycle device 100. FIG. 1 shows the powered unicycle device 100 with a casing 110 in a closed configuration so that it encases a single wheel 120. Here, the casing 110 is formed from a first, upper portion 110A that covers the top (uppermost) half of the wheel 120, and a second, lower portion 110B that covers the bottom (lowermost) half of the wheel 120. FIG. 2 illustrates an exploded view of components internal to the casing 110, namely a wheel 120 and drive arrangement 135.

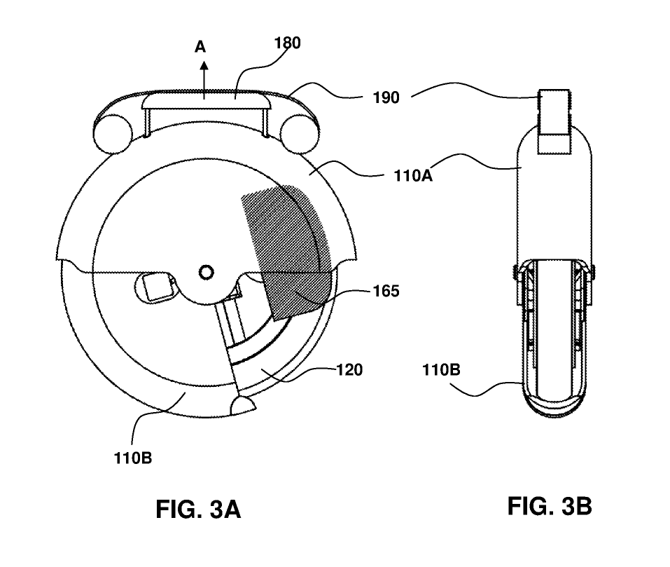

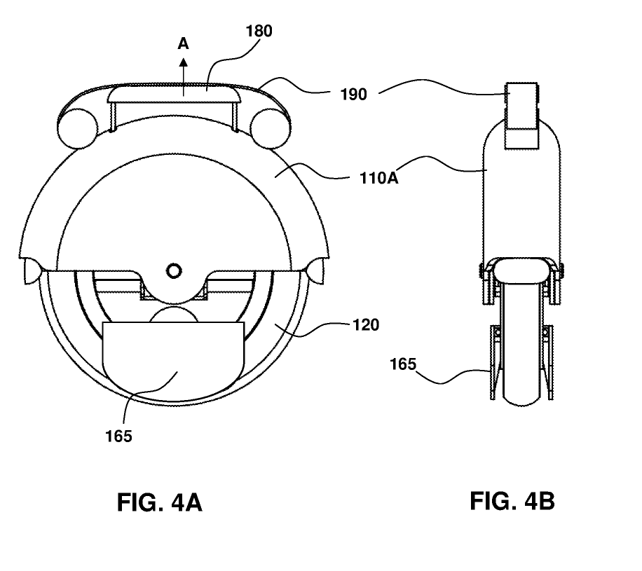

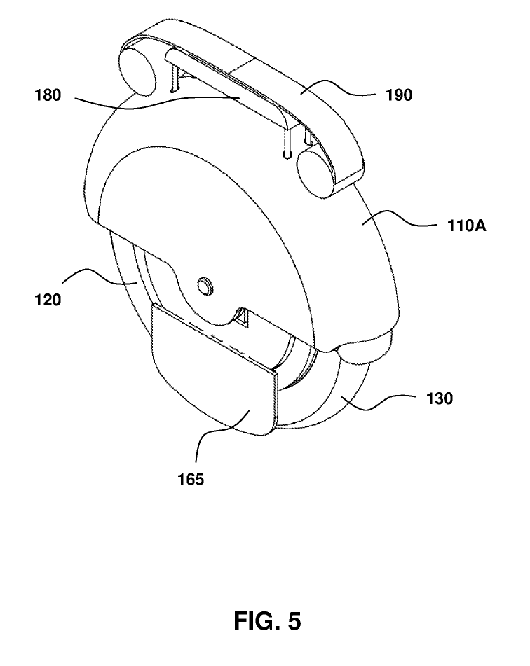

Referring back to FIG. 1, the wheel 120 spins about a central axis 125. The first, upper portion 110A of the casing is retained in a fixed position relative to the central axis 125, whereas the second, lower portion 110B of the casing is adapted to rotate about the central axis 125. Rotation of the second lower portion 110B about the central axis 125 moves the casing between closed and open configurations (as illustrated by FIGS. 3-4). In the closed configuration (shown in FIG. 1), the casing 110 encloses the wheel 120 so that the outer rim 130 of the wheel 120 is not exposed. In the open configuration (shown in FIG. 5), the outer rim 130 of the wheel 120 is exposed so that it can contact a ground surface.

Referring now to FIG. 2, rotation of the single wheel 120 is driven by a drive arrangement 135. The drive arrangement 135 includes guide wheels 140 attached to an outwardly facing side of respective batteries 145. In this embodiment, there are two pairs of guide wheels 140, wherein the two guide wheels in each pair share the same axis of rotation (e.g. by sharing the same axle) and are positioned spaced apart to provide a gap between the two guide wheels.

A rib 150 is provided around the inner rim of the wheel 120 and fits into the gap between the two guide wheels 140 in each pair. The guide wheels 140 are therefore adapted to contact with the inner rim of wheel 120 where they spin along with wheel 120 and hold wheel 120 in place by way of the rib 150. Of course, it will be appreciated that other arrangements, including those with only one guide wheel per battery 145, are possible.

The batteries 145 are mounted on a motor 155 which drives a drive wheel 160 positioned at the lowermost point along the inner rim of the wheel 120. The batteries 145 supply power to motor 155 and, this embodiment, there are two batteries in order to create a balanced distribution of volume and weight. However, it is not necessary to employ two batteries 145. Also, alternative energy storage arrangements may be used, such as a flywheel, capacitors, and other known power storage devices for example.

The drive wheel 160 is adapted to contact the inner rim of the wheel 120. Here, the drive wheel 160 comprises a wide roller with a groove in the center into which the rib 150 fits. By way of contact with the inner rim of the wheel 120, the drive wheel 160 transmits torque from the motor 155 to the wheel 120. It will be understood that this drive system operates by friction and it may be preferable to avoid slippage between the drive wheel 160 and the inner rim of wheel 120. Positioning the drive wheel 160 at the lowermost point enables the weight of a user to provide a force which presses the drive wheel 160 against the inner rim of the wheel 120, thereby helping to reduce or avoid slippage.

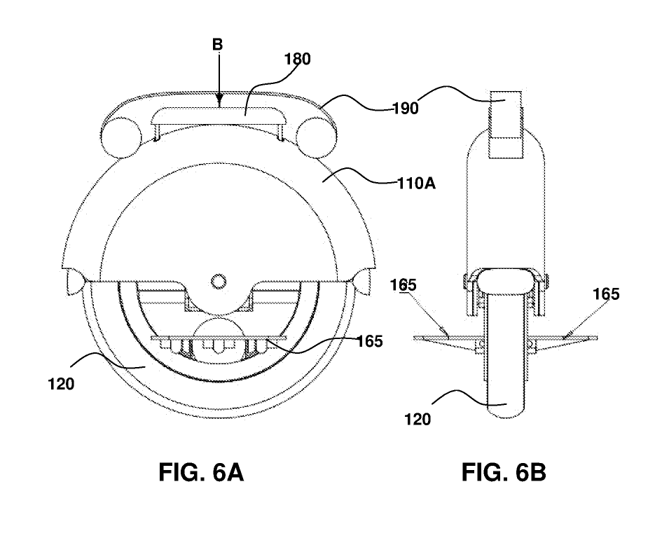

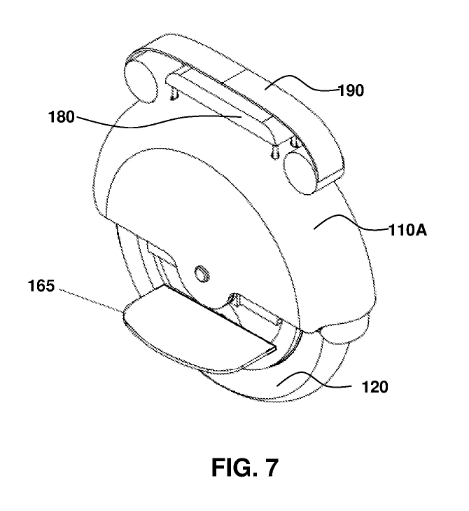

Referring to FIGS. 5-7, two foot platforms 165 are coupled to the second, lower portion 110B of the casing 110, with one on each side of wheel 120. In the open configuration, the foot platforms 165 are movable between a stowed configuration, wherein the foot platforms are substantially parallel with the plane of the wheel (as shown in FIG. 5), and an active configuration, wherein then foot platforms, are substantially perpendicular to the plane of the wheel (as shown in FIGS. 6-7) so as to support a user's weight. Thus, in this embodiment, the foot platforms 165 are movable between: (i) a stowed configuration wherein they are flat against the side of the wheel and can be rotated (with the second, lower portion 110B of the casing) about the central axis 125 so as to be positioned inside (and covered by) the first, upper portion 110A of the casing; and (ii) an active configuration, wherein they project outwardly from the side of the wheel to provide a support surface for the feet of a user. Accordingly, the foot platforms 165 are upwardly foldable into a stowed configuration that narrows the profile of the unicycle 100 to aid in storage and carrying. In use, the foot platforms are moved to the active configuration, and the user stands with one foot on each platform 165.

The drive arrangement 135 includes a gyroscope or accelerometer system 170 which it senses forward and backward tilt of the device in relation to the ground surface and regulates the motor 155 accordingly to keep the device upright. In this way, the user is provided a way of controlling the acceleration and deceleration of the unicycle by varying the pressure applied to various areas of the foot platforms 165. It also enables the unicycle to self-regulate its balance in the fore-and-aft plane.

When not in use, the foot platforms 165 are moved to the stowed configuration and then rotated (with the second, lower portion 110B of the casing) about the central axis 125 so as to move the casing to the closed configuration. Thus, in the closed configuration, the foot platforms 165 are stored inside the casing (covered by the first, upper portion 110A of the casing).

The embodiment of FIGS. 1-7 also comprises a lifting handle 180 coupled to the drive arrangement 135 via a plurality of rods 185. The lifting handle 180 is positioned at the top of the casing 110, above the wheel 120, and may be used to hold the unicycle 100 above the ground, for example to enable a user to lift, carry, convey or place the unicycle 100.

A retractable carrying strap 190 is also provided and attached to the top of the casing 100. The carrying strap 190 may be used to carry the unicycle 100, for example over the shoulder of user. A hook may be provided on the bottom of the case to create rucksack-like belts from the carrying strap 190.

Here, the handle 180 is also adapted to trigger an activating system which moves the casing between the closed and open configurations. More specifically, movement of the handle relative to the casing 110 in an outward direction (away from the centre of the wheel 120) as depicted by an arrow labeled “A”, triggers the activating system which in turn causes the second, lower portion 110B of the casing to rotate about the central axis to move from the closed configuration to the open configuration. This process of rotating the second, lower portion 110B of the casing from the closed configuration to the open configuration is depicted by FIGS. 3-4.

It will therefore be understood that, in this embodiment, the lifting handle 180 may be used to initiate the activating system and move the casing from the closed configuration to the open configuration. Thus, when a user holds the unicycle 100 by the handle above the ground, the force of the unicycle pulling downwards under the influence of gravity causes upward movement of the lifting handle 180 relative to the casing 110 (as depicted by an arrow labeled “A”) which triggers the activating system. In response to this trigger, the activating system moves the casing to the open configuration (depicted in FIGS. 4 & 5) so that the lowermost portion of the wheel is exposed and can be brought into contact with a ground surface. In other words, when lifted by the lifting handle 180, the unicycle may be arranged in an open configuration ready for deployment (e.g. placement on a ground surface).

Further, when placed on the ground, the depression of the handle in a downward/inward direction (towards the centre of the wheel 120) as depicted by an arrow labeled “B” moves the rods 185 and cause the foot platforms to move from the stowed configuration (shown in FIGS. 4 & 5) to the active configuration (shown in FIGS. 6 & 7). Here, downward movement of the rods causes the foot platforms 165 to rotate about an axis and the rods then hold the foot platforms 165 in place to support the feet of user.

When the user no longer desires to use the unicycle, the user pulls on the lifting handle to lift the unicycle from the ground. This results in upward movement of the lifting handle 180 and the associated rods 185 relative to the casing 110 (as depicted by an arrow labeled “A”) which then causes the foot platforms to move from the active configuration (shown in FIGS. 6 & 7) to the stowed configuration (shown in FIGS. 4 & 5).

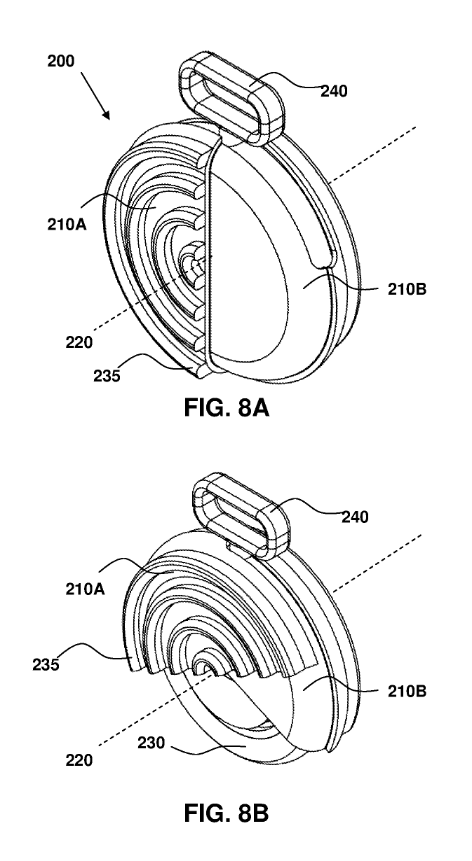

FIG. 8 depicts another embodiment 200 moving between a closed configuration (FIG. 8A) and an open configuration (FIG. 8B). Here, the casing 210 is formed from first 210A and second 210B casing portions which each are adapted to rotate about a central axis 220 in opposite directions. Here, when viewed from one side, the first casing portion 210A is adapted to cover the left half of the wheel 230, and the second casing portion 210B is adapted to cover the right half of the wheel 230. Moving from the closed configuration to the open configuration, the first casing portion 210A rotates in a clock-wise direction about the central axis 220, and the second casing portion 210B rotates in an anti-clockwise direction about the central axis. This opposing rotation of the first 210A and second 210B casing portions exposes the lowermost portion of the wheel 230 in the open configuration so that it can contact a ground surface. Reversal of this rotation then moves the casing 210 from the open configuration to the closed configuration.

Grip surfaces 235 protrude outwardly from the side of the first casing portion 210A so that they may contact the leg, knee, calves, ankle and/or foot of a user. Such protrusion of the grip surfaces 235 from the side of the casing 210 allows them to contact the user when a user uses the unicycle (e.g. stands on the foot platforms). It also enable the grip surfaces 235 to come into contact a ground/floor surface if the unicycle falls over (due to the user falling or stepping off the foot platforms for example). The grip surfaces 235 are formed form a slightly soft material, such as rubber for example. The grip surfaces 235 may therefore perform multiple functions, including the provision of friction against a user's leg(s), protection of the casing from hitting a ground/floor surface, and/or the provision of grip between the side of the casing and the ground/floor surface (to prevent the casing from sliding along the ground/floor in an accident for example). The grip surfaces 235 may thus provide not only for improved stability and comfort of the user, but also for improved safety and to protect the wheel.

It is also noted that the embodiment of FIG. 8 comprises a single rigid handle 240 at the top of the casing 210 above the wheel 230. Here, the handle 240 is designed to enable a user to lift and carry the unicycle 200, and a button (not shown) is provided on the underside of the top of the handle. Pressing the button triggers the activating system which causes the casing 210 to move between the open and closed configuration, by means of an electronic motor for example.

While specific embodiments have been described herein for purposes of illustration, various modifications will be apparent to a person skilled in the art and may be made without departing from the scope of the invention.

For example, it will be appreciated that a variation on the hubless drive arrangement described above is one based on gear transmission instead of friction. The drive wheel may be replaced by a gear, and accordingly the inner rim of the wheel may have alternating protruding and indented segments (i.e. “teeth”).

Also, grip surfaces provided on the casing need not be arranged in the concentric circle fashion depicted in FIG. 8. Other arrangements of grips surfaces may be used on all or part of the casing. For example, in one embodiment, a single grip surface may be provided covering substantially all of the side of a casing portion. Alternatively, the grip surface may be formed from an array of regular or irregular shapes arranged in a repeating or random pattern. Crisscrossed, polka-dot and/or interweaved patterns of grips surfaces may therefore be envisaged.

On the other hand, embodiments need not employ a hubless wheel, but may instead employ a hub motor (a type of motor well known in the art).

Although an embodiment has been described which uses a lifting handle to trigger a system which moves the unicycle casing between an open and closed configuration, other concepts may be used to alter the configuration of the casing. For example, an electronic activation system may be used which is responsive to one or more signals indicating that the user intends to use the unicycle. Such signals may be provided from a user input interface (such as a button, switch or a touchscreen for example) and/or a movement detection system (employing accelerometers for example) which detects predetermined movement of the unicycle. Alternatively, a mechanical arrangement may be used which moves the casing between the open and closed configurations when a mechanical trigger, lock or release is moved. A combination of both mechanical and electronic systems may also be employed for moving the unicycle casing between the open and closed configurations. For example, sensors may be provided on or around the user's legs and feet to detect when a user is standing on the foot platforms, control the unicycle with greater precision, or improved steering capabilities. Such sensors may be used to provide a locking signal that prevents the device being moved to the closed configuration when a user is standing on the foot platforms (i.e. using the device). Sensors may also be employed to provide a safety signal which disables the unicycle or places the unicycle in a safe mode, for example, upon detection of one or more conditions. A tyre pressure sensor may be employed to detect the air pressure of an air-inflated wheel so as to provide a signal that may be used for safety purposes and/or improved control of the unicycle.

1. A powered unicycle device, comprising:
a single wheel;
a motor adapted to drive the wheel;
a balance control system adapted to maintain fore-aft balance of the unicycle device;
at least one foot platform for supporting a user of the unicycle device; and
a casing comprising at least two casing portions adapted to be movable between a closed configuration, in which an outer rim of the wheel is substantially covered, and an open configuration, in which at least a portion of the outer rim of the wheel is exposed for contacting a ground surface.

2. The powered unicycle device of claim 1, further comprising an activating system adapted to move the casing from the closed configuration to the open configuration.

3. The powered unicycle device of claim 2, wherein the activating system comprises a handle.

4. The powered unicycle device of claim 2, wherein the activating system is responsive to an indication that the user intends to use the unicycle device.

5. The powered unicycle device of claim 4, wherein the indication is provided from at least one of: an accelerometer system detecting movement of the unicycle device; an input interface receiving a user input; movement of the activating system relative to the casing; one or more sensors; or actuation of a switch.

6. The powered unicycle device of claim 3, wherein the at least one foot platform is movable between a stowed position and an active position by movement of the handle relative to the casing.

7. The powered unicycle device of claim 1, wherein a first casing portion of the at least two casing portions is adapted to rotate relative to a second casing portion of the at least two casing portions about an axis of rotation of the wheel.

8. The powered unicycle device of claim 1, wherein the at least one foot platform is coupled to a first casing portion of the at least two casing portions.

9. The powered unicycle device of claim 1, wherein the at least one foot platform is movable between a stowed position and an active position in response to the at least two casing portions moving between the closed configuration and the open configuration.

10. The powered unicycle device of claim 1, wherein said wheel is hubless, and wherein the unicycle device further comprises at least one drive wheel driven by said motor and in contact with an inner rim of the wheel.

11. The powered unicycle device of claim 1, further comprising at least one grip surface made of yielding material and protruding outward from a side of the casing.

12. (canceled)
